(19) United States
(12) Patent Application Publication
(10) Pub. No.: US 2018/0007488 A1
(43) Pub. Date: Jan. 4, 2018

(54) SOUND SOURCE RENDERING IN VIRTUAL ENVIRONMENT

(71) Applicants: Ronald Jeffrey Horowitz, Vallejo, CA (US); Wing Chris Ho, Cupertino, CA (US)

(72) Inventors: Ronald Jeffrey Horowitz, Vallejo, CA (US); Wing Chris Ho, Cupertino, CA (US)

(21) Appl. No.: 15/201,201

(22) Filed: Jul. 1, 2016

(51) Int. Cl. H04S 7/00; G02B 27/00; H04R 5/04; G06F 3/01; G02B 27/01

(52) U.S. Cl. CPC H04S 7/303; G06F 3/012; G02B 27/017; H04R 5/04; G02B 27/0093; G06F 3/011; H04S 2400/11; H04S 2420/01

(57) ABSTRACT

Embodiments are directed to sound source rendering in a virtual reality (VR) system that executes an immersive virtual environment including at least one virtual sound source. A motion sensor to produces a measurement of a motion of the user, and an imaging sensor is used to produce an indication of at least one physical feature of the user relevant to sound perception. A sound rendering engine determines and applies a head-related transfer function (HRTF) based on the at least one physical feature of the user, and effects a source direction of sound from the at least one virtual sound source according to a frame of reference of the user based on the motion of the user.

### TECHNICAL FIELD

Embodiments described herein generally relate to information processing and user interfaces and, more particularly, to virtual-reality (VR) systems and methods.

### BACKGROUND

Virtual reality (VR) systems provide an immersive experience for a user by simulating the user's presence in a computer-modeled environment, and facilitating user interaction with that environment. In typical VR implementations, the user wears a head-mounted display (HMD) that provides a stereoscopic display of the virtual environment. Some systems include sensors that track the user's head movement and hands, allowing the viewing direction to be varied in a natural way when the user turns their head about, and for the hands to provide input and, in some cases, be represented in the VR space.

Sound sources may also be modeled in the virtual environment, and presented to the user via an audio system, such as a binaural playback system, that has headphones/earphones wearable by the user. However, there are a number of challenges particular to accurate, realistic, sound reproduction. For instance, human perception of a sound source, including such features as the location of the source, and the spectral characteristics of the sound it produces, may vary significantly from one individual to another due to physiological differences between individuals.

### BRIEF DESCRIPTION OF THE DRAWINGS

In the drawings, which are not necessarily drawn to scale, like numerals may describe similar components in different views. Like numerals having different letter suffixes may represent different instances of similar components. Some embodiments are illustrated by way of example, and not limitation, in the figures of the accompanying drawings.

FIG. 1 is a high-level system diagram illustrating some examples of components of a VR system that may employ aspects of the embodiments.

FIG. 2 is a block diagram illustrating an exemplary system architecture of a processor-based computing device according to an embodiment.

FIG. 3 is a diagram illustrating an exemplary hardware and software architecture of a computing device such as the one depicted in FIG. 2, in which various interfaces between hardware components and software components are shown.

FIG. 4 is a block diagram illustrating examples of processing devices that may be implemented on a computing platform, such as the computing platform described with reference to FIGS. 2-3, according to an embodiment.

FIG. 5 is a block diagram illustrating some of the various engines implemented on a computing platform according to one type of embodiment, to make a special-purpose machine for executing a virtual environment.

FIG. 6 is a block diagram illustrating some of the components of sound rendering engine according to some embodiments.

FIG. 7 is a block diagram illustrating some of the components of an HRTF manager according to an embodiment.

FIG. 8 is a process flow diagram illustrating example operations performed by a virtual reality system according to an embodiment.

### DETAILED DESCRIPTION

Aspects of the embodiments are directed to a virtual reality (VR) processing system that provides its user an interface with which to explore, or interact with, the 3D virtual environment (VE). Some embodiments are particularly directed to improving the realism of sounds provided to the user. In one aspect of the disclosure, a sound source is modeled to include its relative location and orientation to the user. The sound from this sound source is adapted to be perceived by the user to be in its relative position, meaning the user is provided a binaural soundscape that contains spectral and stereophonic temporal features that are indicative of the sound source's relative location and orientation to the user. In a related embodiment, one or more sensors are utilized to detect changes in the user's relative position or orientation to the sound source, and to vary the user-perceived direction of the sound source in the sound output.

In another aspect of the embodiments, a head-related transfer function (HRTF) is utilized to adapt the qualities of the sound to physical features of the user that have a role in the user's perception of sound. For instance, the size and shape of the user's head, torso, ears, hair, and other such features, are taken into account when adapting the sound. In a related embodiment, an imaging sensor, such as a three-dimensional imaging sensor, is utilized to gather the parameters of the user's physical features, from which the HRTF may be selected or derived.

Aspects of the embodiments may be implemented as part of a computing platform. The computing platform may be one physical machine, or may be distributed among multiple physical machines, such as by role or function, or by process thread in the case of a cloud computing distributed model. In various embodiments, aspects of the invention may be configured to run in virtual machines that in turn are executed on one or more physical machines. For example, the computing platform may include a processor-based system located on a head-mounted display (MID) device, it may include a stand-alone computing device such as a personal computer, smartphone, tablet, remote server, etc., or it may include some combination of these. It will be understood by persons of skill in the art that features of the invention may be realized by a variety of different suitable machine implementations.

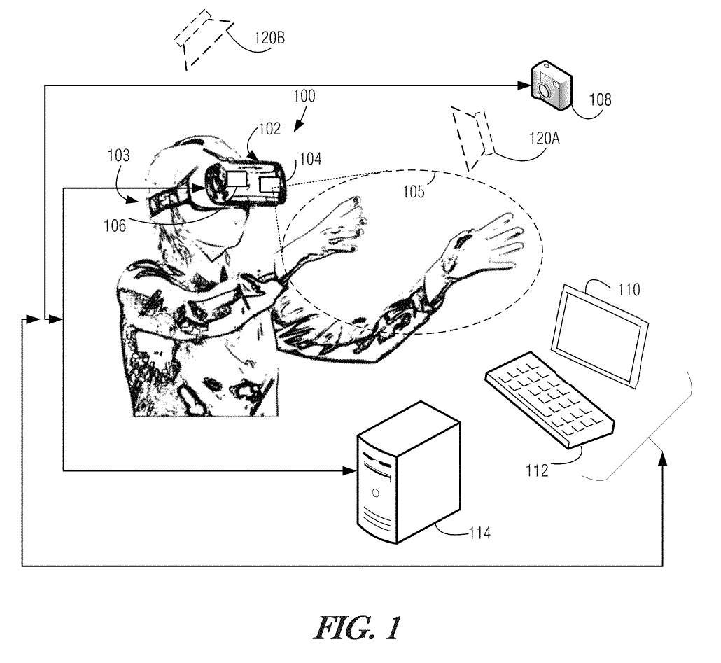

FIG. 1 is a high-level system diagram illustrating some examples of hardware components of a VR system that may be employed according to some aspects of the embodiments. HMD device 100 to be worn by the user includes display 102 facing the user's eyes. In various embodiments, display 102 may include stereoscopic, autostereoscopic, or virtually 3D display technologies. In a related embodiment, the HMD device may have another form factor, such as smart glasses, that offer a semi-transparent display surface.

HMD device 100 also includes an audio system 103 that plays sounds to be heard by the user via a pair of earphones or headphones, which may be integrated with HMD device 100. Audio system 103 may synthesize sounds, or it may play back sound recordings. In a related embodiment, one or more sources of sound are modeled to represent their location and orientation relative to the user. For instance, as depicted in FIG. 1, virtual sound source 120A at a location facing the user from the front, and virtual sound source 120B situated above and behind the user, may each be dynamically modeled in a way that allows the user to perceive its relative position and orientation to the user. Accordingly, if a user changes his or her position, the sound-source direction, to be perceived by the user, is adjusted commensurate with the change in position.

In the embodiment depicted, HMD device 100 may include a set of sensors 104, such as motion sensors to detect head movement, eye-movement sensors, and hand movement sensors to monitor motion of the user's arms and hands in monitored zone 105.

HMD device 100 also includes a processor-based computing platform 106 that is interfaced with display 102 and sensors 104, and configured to perform a variety of data-processing operations that may include interpretation of sensed inputs, virtual-environment modeling, graphics rendering, user-interface hosting, other output generation (e.g., sound, haptic feedback, etc.), data communications with external or remote devices, user-access control and other security functionality, or some portion of these, and other, data-processing operations.

The VR system may also include external physical-environment sensors that are separate from HMD device 100. For instance, camera 108 may be configured to monitor the user's body movements including limbs, head, overall location within the user's physical space, and the like. Camera 108 may also be used to collect information regarding the user's physical features. In a related embodiment, camera 108 includes three-dimensional scanning functionality to assess the user's physical features. Touchscreen 110 may be used to accept user input, and provide some visual output for the user as well. Input device 112, may be a keyboard, as depicted, but may also have a different form factor, such as a gaming controller, mouse, trackpad, trackball, sensing glove, and the like. The external physical-environment sensors may be interfaced with HMD system 100 via a local-area network, personal-area network, or interfaced via device-to-device interconnection. In a related embodiment, the external physical-environment sensors may be interfaced via external computing platform 114.

External computing platform 114 may be situated locally (e.g., on a local area network, personal-area network, or interfaced via device-to-device interconnection) with HMD device 100. In a related embodiment, external computing platform 114 may be situated remotely from HMD device 100 and interfaced via a wide-area network such as the Internet. External computing platform 114 may be implemented via a server, a personal computer system, a mobile device such as a smartphone, tablet, or some other suitable computing platform. In one type of embodiment, external computing platform 114 performs some or all of the functionality of computing platform 106 described above, depending on the computational capabilities of computing platform 106. Data processing may be distributed between computing platform 106 and external computing platform 114 in any suitable manner. For instance, more computationally-intensive tasks, such as graphics rendering, user-input interpretation, 3-D virtual environment modeling, sound generation and sound quality adaptation, and the like, may be allocated to external computing platform 114. Regardless of whether, and in what manner, the various VR system functionality is distributed among one or more computing platforms, all of the (one or more) computing platforms may collectively be regarded as sub-parts of a single overall computing platform in one type of embodiment, provided of course that there is a data communication facility that allows the sub-parts to exchange information.

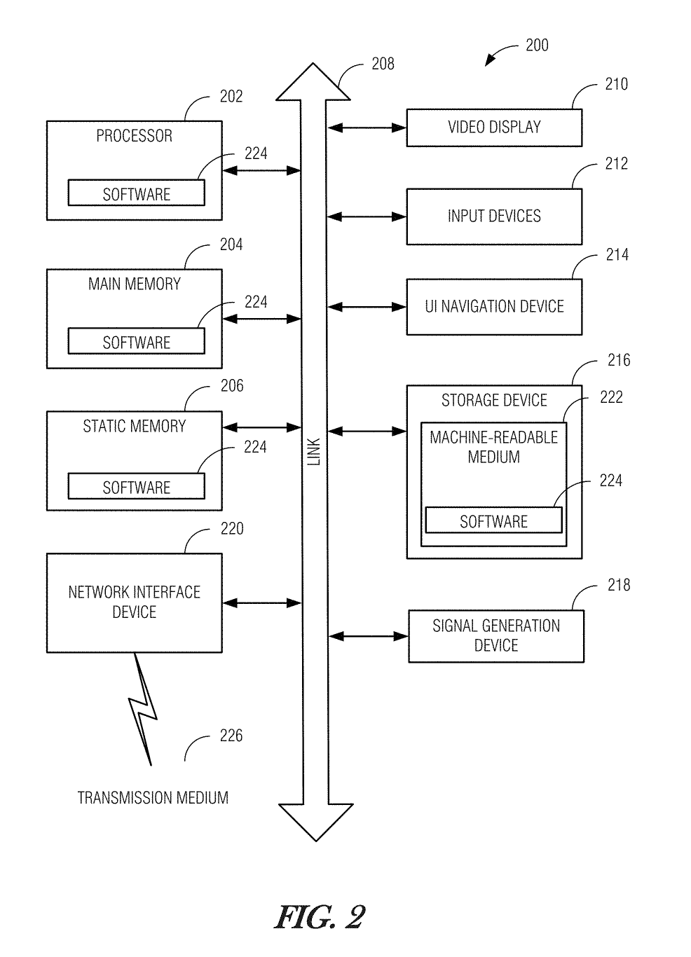

FIG. 2 is a block diagram illustrating a computing platform in the example form of a general-purpose machine. In certain embodiments, programming of the computing platform 200 according to one or more particular algorithms produces a special-purpose machine upon execution of that programming In a networked deployment, the computing platform 200 may operate in the capacity of either a server or a client machine in server-client network environments, or it may act as a peer machine in peer-to-peer (or distributed) network environments. Computing platform 200, or some portions thereof, may represent an example architecture of computing platform 106 or external computing platform 114 according to one type of embodiment.

Example computing platform 200 includes at least one processor 202 (e.g., a central processing unit (CPU), a graphics processing unit (GPU) or both, processor cores, compute nodes, etc.), a main memory 204 and a static memory 206, which communicate with each other via a link 208 (e.g., bus). The computing platform 200 may further include a video display unit 210, input devices 212 (e.g., a keyboard, camera, microphone), and a user interface (UI) navigation device 214 (e.g., mouse, touchscreen). The computing platform 200 may additionally include a storage device 216 (e.g., a drive unit), a signal generation device 218 (e.g., a speaker), and a network interface device (NID) 220.

The storage device 216 includes a machine-readable medium 222 on which is stored one or more sets of data structures and instructions 224 (e.g., software) embodying or utilized by any one or more of the methodologies or functions described herein. The instructions 224 may also reside, completely or at least partially, within the main memory 204, static memory 206, and/or within the processor 202 during execution thereof by the computing platform 200, with the main memory 204, static memory 206, and the processor 202 also constituting machine-readable media.

While the machine-readable medium 222 is illustrated in an example embodiment to be a single medium, the term “machine-readable medium” may include a single medium or multiple media (e.g., a centralized or distributed database, and/or associated caches and servers) that store the one or more instructions 224. The term “machine-readable medium” shall also be taken to include any tangible medium that is capable of storing, encoding or carrying instructions for execution by the machine and that cause the machine to perform any one or more of the methodologies of the present disclosure or that is capable of storing, encoding or carrying data structures utilized by or associated with such instructions. The term “machine-readable medium” shall accordingly be taken to include, but not be limited to, solid-state memories, and optical and magnetic media. Specific examples of machine-readable media include non-volatile memory, including but not limited to, by way of example, semiconductor memory devices (e.g., electrically programmable read-only memory (EPROM), electrically erasable programmable read-only memory (EEPROM)) and flash memory devices; magnetic disks such as internal hard disks and removable disks; magneto-optical disks; and CD-ROM and DVD-ROM disks.

NID 220 according to various embodiments may take any suitable form factor. In one such embodiment, NID 220 is in the form of a network interface card (NIC) that interfaces with processor 202 via link 208. In one example, link 208 includes a PCI Express (PCIe) bus, including a slot into which the NIC form-factor may removably engage. In another embodiment, NID 220 is a network interface circuit laid out on a motherboard together with local link circuitry, processor interface circuitry, other input/output circuitry, memory circuitry, storage device and peripheral controller circuitry, and the like. In another embodiment, NID 220 is a peripheral that interfaces with link 208 via a peripheral input/output port such as a universal serial bus (USB) port. NID 220 transmits and receives data over transmission medium 226, which may be wired or wireless (e.g., radio frequency, infra-red or visible light spectra, etc.), fiber optics, or the like.

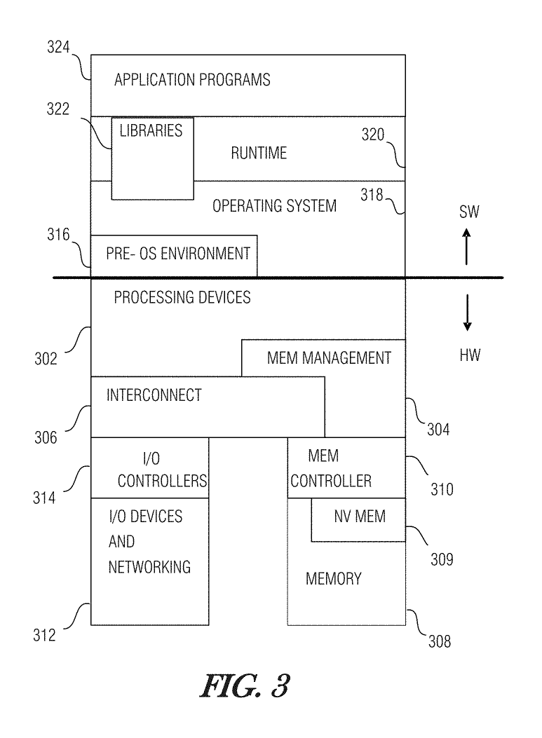

FIG. 3 is a diagram illustrating an exemplary hardware and software architecture of a computing device such as the one depicted in FIG. 2, in which various interfaces between hardware components and software components are shown. As indicated by HW, hardware components are represented below the divider line, whereas software components denoted by SW reside above the divider line. On the hardware side, processing devices 302 (which may include one or more microprocessors, digital signal processors, etc., each having one or more processor cores, are interfaced with memory management device 304 and system interconnect 306. Memory management device 304 provides mappings between virtual memory used by processes being executed, and the physical memory. Memory management device 304 may be an integral part of a central processing unit which also includes the processing devices 302.

Interconnect 306 includes a backplane such as memory, data, and control lines, as well as the interface with input/output devices, e.g., PCI, USB, etc. Memory 308 (e.g., dynamic random access memory—DRAM) and non-volatile memory 309 such as flash memory (e.g., electrically-erasable read-only memory—EEPROM, NAND Flash, NOR Flash, etc.) are interfaced with memory management device 304 and interconnect 306 via memory controller 310. This architecture may support direct memory access (DMA) by peripherals in one type of embodiment. I/O devices, including video and audio adapters, non-volatile storage, external peripheral links such as USB, Bluetooth, etc., as well as network interface devices such as those communicating via Wi-Fi or LTE-family interfaces, are collectively represented as I/O devices and networking 312, which interface with interconnect 306 via corresponding I/O controllers 314.

On the software side, a pre-operating system (pre-OS) environment 316, which is executed at initial system start-up and is responsible for initiating the boot-up of the operating system. One traditional example of pre-OS environment 316 is a system basic input/output system (BIOS). In present-day systems, a unified extensible firmware interface (UEFI) is implemented. Pre-OS environment 316, is responsible for initiating the launching of the operating system, but also provides an execution environment for embedded applications according to certain aspects of the invention.

Operating system (OS) 318 provides a kernel that controls the hardware devices, manages memory access for programs in memory, coordinates tasks and facilitates multi-tasking, organizes data to be stored, assigns memory space and other resources, loads program binary code into memory, initiates execution of the application program which then interacts with the user and with hardware devices, and detects and responds to various defined interrupts. Also, operating system 318 provides device drivers, and a variety of common services such as those that facilitate interfacing with peripherals and networking, that provide abstraction for application programs so that the applications do not need to be responsible for handling the details of such common operations. Operating system 318 additionally provides a graphical user interface (GUI) engine that facilitates interaction with the user via peripheral devices such as a monitor, keyboard, mouse, microphone, video camera, touchscreen, and the like.

Runtime system 320 implements portions of an execution model, including such operations as putting parameters onto the stack before a function call, the behavior of disk input/output (I/O), and parallel execution-related behaviors. Runtime system 320 may also perform support services such as type checking, debugging, or code generation and optimization.

Libraries 322 include collections of program functions that provide further abstraction for application programs. These include shared libraries, dynamic linked libraries (DLLs), for example. Libraries 322 may be integral to the operating system 318, runtime system 320, or may be added-on features, or even remotely-hosted. Libraries 322 define an application program interface (API) through which a variety of function calls may be made by application programs 324 to invoke the services provided by the operating system 318. Application programs 324 are those programs that perform useful tasks for users, beyond the tasks performed by lower-level system programs that coordinate the basis operability of the computing device itself.

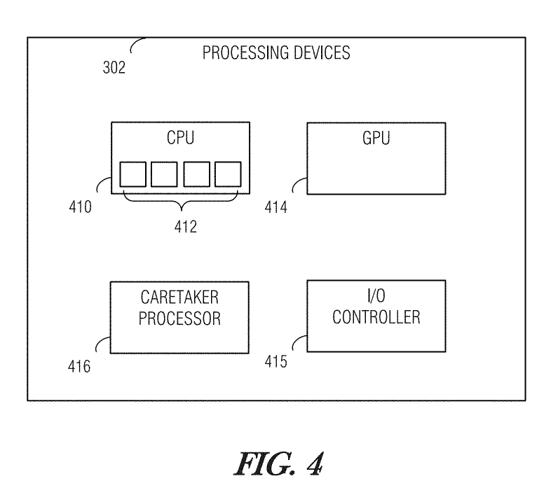

FIG. 4 is a block diagram illustrating processing devices 302 according to one type of embodiment. One, or a combination, of these devices may constitute processor 120 in one type of embodiment. CPU 410 may contain one or more processing cores 412, each of which has one or more arithmetic logic units (ALU), instruction fetch unit, instruction decode unit, control unit, registers, data stack pointer, program counter, and other essential components according to the particular architecture of the processor. As an illustrative example, CPU 410 may be a x86-type of processor. Processing devices 302 may also include a graphics processing unit (GPU) 414. In these embodiments, GPU 414 may be a specialized co-processor that offloads certain computationally-intensive operations, particularly those associated with graphics rendering, from CPU 410. Notably, CPU 410 and GPU 414 generally work collaboratively, sharing access to memory resources, I/O channels, etc.

Processing devices 302 may also include caretaker processor 416 in one type of embodiment. Caretaker processor 416 generally does not participate in the processing work to carry out software code as CPU 410 and GPU 414 do. In one type of embodiment, caretaker processor 416 does not share memory space with CPU 410 and GPU 414, and is therefore not arranged to execute operating system or application programs. Instead, caretaker processor 416 may execute dedicated firmware that supports the technical workings of CPU 410, GPU 414, and other components of the computing platform. In one type of embodiment, caretaker processor is implemented as a microcontroller device, which may be physically present on the same integrated circuit die as CPU 410, or may be present on a distinct integrated circuit die. Caretaker processor 416 may also include a dedicated set of I/O facilities to enable it to communicate with external entities. In one type of embodiment, caretaker processor 416 is implemented using a manageability engine (ME) or platform security processor (PSP). Input/output (I/O) controller 415 coordinates information flow between the various processing devices 410, 414, 416, as well as with external circuitry, such as a system interconnect.

Examples, as described herein, may include, or may operate on, logic or a number of components, engines, or engines, which for the sake of consistency are termed engines, although it will be understood that these terms may be used interchangeably. Engines may be hardware, software, or firmware communicatively coupled to one or more processors in order to carry out the operations described herein. Engines may be hardware engines, and as such engines may be considered tangible entities capable of performing specified operations and may be configured or arranged in a certain manner In an example, circuits may be arranged (e.g., internally or with respect to external entities such as other circuits) in a specified manner as an engine. In an example, the whole or part of one or more computing platforms (e.g., a standalone, client or server computing platform) or one or more hardware processors may be configured by firmware or software (e.g., instructions, an application portion, or an application) as an engine that operates to perform specified operations. In an example, the software may reside on a machine-readable medium. In an example, the software, when executed by the underlying hardware of the engine, causes the hardware to perform the specified operations. Accordingly, the term hardware engine is understood to encompass a tangible entity, be that an entity that is physically constructed, specifically configured (e.g., hardwired), or temporarily (e.g., transitorily) configured (e.g., programmed) to operate in a specified manner or to perform part or all of any operation described herein.

Considering examples in which engines are temporarily configured, each of the engines need not be instantiated at any one moment in time. For example, where the engines comprise a general-purpose hardware processor configured using software; the general-purpose hardware processor may be configured as respective different engines at different times. Software may accordingly configure a hardware processor, for example, to constitute a particular engine at one instance of time and to constitute a different engine at a different instance of time.

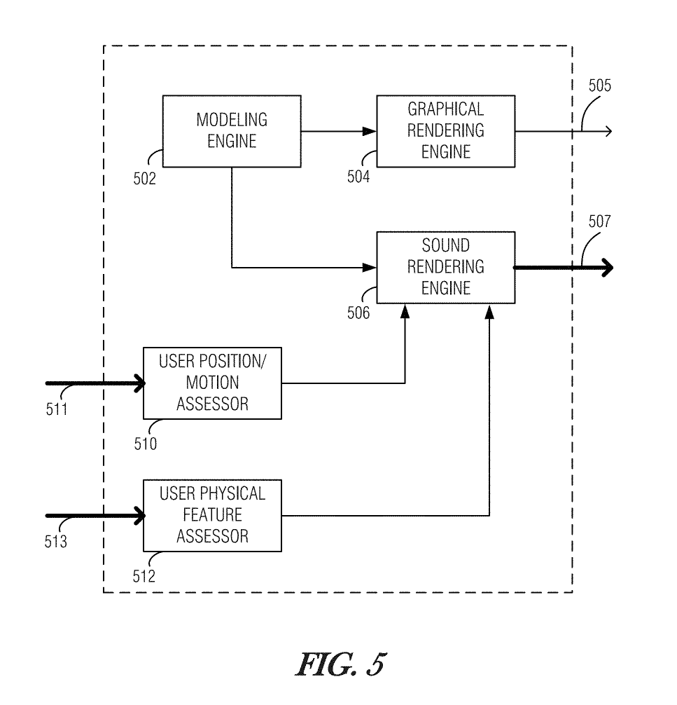

FIG. 5 is a block diagram illustrating some of the various engines implemented on a computing platform 500, according to one type of embodiment, to make a special-purpose machine for executing a virtual environment. As depicted, computing platform 500 includes modeling engine 502, which is constructed, programmed, or otherwise configured, to model a 3D virtual environment (VE), including virtual objects, structures, forces, sound sources, and laws of physics, that may be specific to the particular 3D VE. Graphical rendering engine 504 is constructed, programmed, or otherwise configured, to render perspective-view imagery of parts of the VE, such as from the user's vantage point, and provides the perspective-view imagery output 505 to a display output interface which, in turn, is coupled to a HMD device or other suitable display on which the user views the VE.

Sound rendering engine 506 is constructed, programmed, or otherwise configured, to generate a soundscape of the VE, including taking into account the relative location and orientation of sound sources relative to the user's location and orientation. In a related embodiment, sound rendering engine 506 takes into account motion of the user, and dynamically adjusts the source direction of sounds (e.g., via output 507) to be perceived by the user in response to that motion. Accordingly, user position or motion assessor 510 receives position or motion sensor information 511 from a suitable sensor or combination of sensors, such as an accelerometer, gyroscope or other inertial sensor, magnetometer (e.g., compass), any of which may be incorporated in the HMD. In addition, sensors external to the HMD may provide position or motion information. For instance, a camera, particularly a camera with 3D functionality, may be used to assess a user's motion and orientation. An on-board camera mounted on the HMD and positioned to capture the user's actual surroundings, may also be used to assess certain types of user's motion, for example, whether the user turns his or her head.

Position or motion assessor 510 may be configured to process a variety of sensor inputs from different types of sensors, to detect the position of the user, or the nature and extent of motion of the user. In a related embodiment, position or motion assessor 510 may aggregate multiple sensor outputs to confirm or verify motion/repositioning, or to obtain more finely-detailed measures of the motion/positioning.

Sound rendering engine 506 is further configured to make other corrections to the sound being produced based on a head-related transfer function (HRTF) associated with the user. To effectively ascertain the HRTF for a given user, user physical feature assessor 512 is invoked. In an embodiment, user physical feature assessor 512 accepts as its input 513 imagery of the user. The imagery may be 2D or 3D according to various embodiments. Examples of measured user physical features include, without limitation:
head size (e.g., estimated diameter or circumference);
head shape (e.g., proportions along various axes or other coordinates);
size of ears;
shape of ears;
location of ears relative to a defined part of the head;
size or shape of jaw;
dimensions of neck;
dimensions of shoulders;
dimensions of upper torso;
amount of hair, hairstyle, etc.

The output of user physical feature assessor 512 may include one or more of the above measurements made based on the captured 2D or 3D imagery of the user, and is provided to sound rendering engine 506.

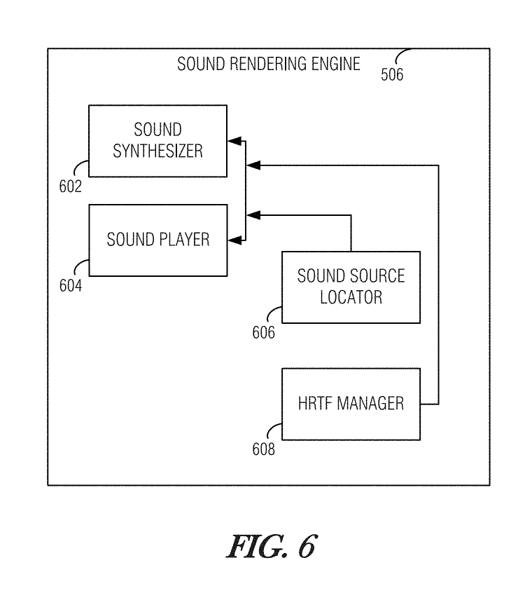

FIG. 6 is a block diagram illustrating some of the components of sound rendering engine 506 according to some embodiments. Sound rendering engine 506 includes sound synthesizer 602 constructed, programmed, or otherwise configured, to generate sounds; as well as sound player 604, which is constructed, programmed, or otherwise configured, to play back stored sounds.

Sound source positioner 606 receives as its input the position or motion assessment of position or motion assessor 510 according to an embodiment, and in response to this information, sound source positioner 606 controls sound synthesizer 602 and sound player 604 to incorporate a sound propagation directionality to be perceived by the user. Any suitable technique or techniques may be applied. For example, inter-aural level different (ILD), inter-aural time difference (ITD), some combination of these techniques, or other like techniques, may be employed.

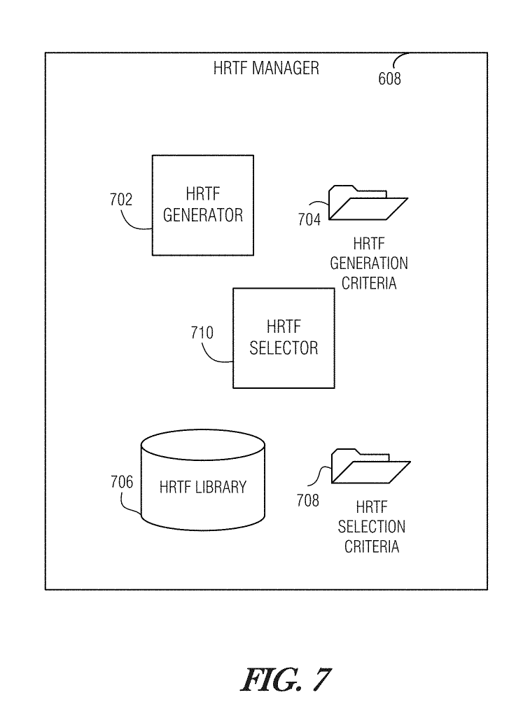

HRTF manager 608 receives as its input a user physical feature assessment, such as the output produced by user physical feature assessor 512, and determines a suitable HRTF for the user. FIG. 7 is a block diagram illustrating some of the components of HRTF manager 608 according to an embodiment. HRTF generator 702 is constructed, programmed, or otherwise configured, to formulaically generate an HRTF based on the user's assessed physical features, and on HRTF generation criteria 704.

HRTF selector 710 is constructed, programmed, or otherwise configured, to select a previously-generated HRTF from HRTF library according to HRTF selection criteria 708. HRTF library may include a variety of HRTFs corresponding to various reference individuals of diverse size and shape. HRTF selection criteria 708 may include a similarity measure to be met between the user and one or more reference individuals of HRTF library 706 for a selection to be valid.

In one type of embodiment, HRTF manager 608 uses only HRTF selector 710; in another embodiment HRTF manager 608 uses only HRTF generator 702. In another type of embodiment, both are used. For instance, HRTF manager 608 may preferentially select a HRTF using HRTF selector 710 if the user is sufficiently similar in physical features to a reference individual from HRTF library 706 (e.g., meets a Euclidian distance measure threshold, for instance, as defined in HRTF selection criteria 708). Otherwise, if the similarity criteria is not met, HRTF generator 702 is invoked to formulaically generate a custom HRTF for the user based on the user's assessed physical features.

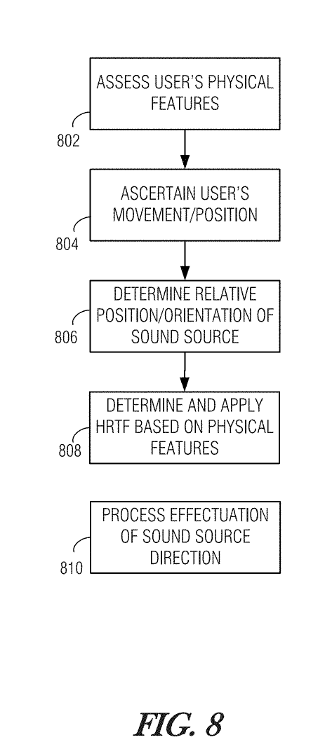

FIG. 8 is a process flow diagram illustrating example operations performed by a virtual reality system, such as system 500, according to an embodiment. It is important to note that the example process may be realized as described; in addition, portions of the process may be implemented while others are excluded in various embodiments. The following Additional Notes and Examples section details various combinations, without limitation, that are contemplated. It should also be noted that in various embodiments, certain process operations may be performed in a different ordering than depicted, provided that the logical flow and integrity of the process is not disrupted in substance.

At 802, user physical feature assessor 512 performs an assessment of the user's physical features, such as those listed above, for example. The assessment may be performed as a system-management operation (e.g., a special calibration procedure), or “on the fly” during VM system operation when a VE is being rendered. The physical feature assessment may include absolute or relative (e.g., physical feature proportion) measurements. In an example embodiment, a 3D camera is used to capture at least one of the physical features to be analyzed for its attributes.

At 804, user position or motion assessor 510 ascertains the user's motion, position, posture, or some combination of these. In an embodiment, this assessment is performed “on the fly” as the user explores the VE, for example. At 806, based on the ascertained position or movement, the system determines the relative positioning or orientation between the user and sound source using sound source positioner 606. Notably, sound source positioner 606 does not change the location of the sound source in the model; rather, sound source positioner 606 adjusts the incoming direction of sound from the sound source in the user's frame of reference, to account for the motion of the user. At 808, HRTF manager 608 determines a suitable HRTF to apply based on the assessed user's physical features. Any one or more of the techniques discussed above, selection or formulaic generation, for example, may be employed in this stage. At 810, sound synthesizer 602, sound player 604, or both, process the sound output to comport with the determined HRTF, and with the sound source positioning.

### Additional Notes & Examples

Example 1 is a system for sound source rendering in a virtual reality (VR) system, the system comprising: a modeling engine to execute an immersive virtual environment that includes at least one virtual sound source; a motion assessor to read an output of a motion sensor to produce an measurement of a motion of the user; a physical feature assessor to read an output of an imaging sensor and produce an indication of at least one physical feature of the user relevant to sound perception by the user; a sound rendering engine to determine and apply a head-related transfer function (HRTF) based on the at least one physical feature of the user, and to effect a source direction of sound from the at least one virtual sound source according to a frame of reference of the user based on the motion of the user; and a sound output device to produce a user-perceptible sound from the virtual sound source based on an output of the sound rendering engine, the sound having directional properties based on the HRTF and source direction.

In Example 2, the subject matter of Example 1 optionally includes a motion sensor to measure motion of a user of the VR system; and an imaging sensor to measure physical features of the user.

In Example 3, the subject matter of any one or more of Examples 1-2 optionally include wherein the output of the imaging sensor includes a 3D model of the at least one physical feature of the user relevant to sound perception.

In Example 4, the subject matter of any one or more of Examples 1-3 optionally include wherein the at least one physical feature of the user relevant to sound perception includes at least one physical feature selected from the group consisting of: head size, head shape, size of ears, shape of ears, location of ears relative to a defined part of the head, characteristics of the jaw, dimensions of the neck, dimensions of the shoulders, dimensions of the upper torso, amount of hair and hairstyle, or any combination thereof.

In Example 5, the subject matter of any one or more of Examples 1-4 optionally include wherein the motion assessor is to read an inertial sensor worn by the user.

In Example 6, the subject matter of any one or more of Examples 1-5 optionally include a head-mounted display operatively coupled to the sound output device.

In Example 7, the subject matter of any one or more of Examples 1-6 optionally include wherein the sound rendering engine to determine the HRTF based on a measure of similarity between the at least one physical feature of the user and a corresponding at least one physical feature of a reference individual associated with a predefined HRTF.

In Example 8, the subject matter of any one or more of Examples 1-7 optionally include wherein the sound rendering engine to determine the HRTF based on an HRTF-generating formula.

In Example 9, the subject matter of any one or more of Examples 1-8 optionally include wherein the physical feature assessor is to read an output of an imaging sensor and produce an indication of at least one physical feature of the user during execution of the VE.

In Example 10, the subject matter of any one or more of Examples 1-9 optionally include wherein the sound rendering engine includes a library of reference individuals having defined physical features associated with corresponding HRTFs.

Example 11 is a method for sound source rendering in a virtual reality (VR) system, the method comprising: executing an immersive virtual environment that includes at least one virtual sound source; reading an output of a motion sensor to produce an measurement of a motion of the user; reading an output of an imaging sensor and producing an indication of at least one physical feature of the user relevant to sound perception by the user; determining and applying a head-related transfer function (HRTF) based on the at least one physical feature of the user to effect a source direction of sound from the at least one virtual sound source according to a frame of reference of the user based on the motion of the user; and producing a user-perceptible sound from the virtual sound source based on an output of the sound rendering engine, the sound having directional properties based on the HRTF and source direction.

In Example 12, the subject matter of Example 11 optionally includes wherein reading the output of the imaging sensor includes reading a 3D model of the at least one physical feature of the user relevant to sound perception.

In Example 13, the subject matter of any one or more of Examples 11-12 optionally include wherein the at least one physical feature of the user relevant to sound perception includes at least one physical feature selected from the group consisting of: head size, head shape, size of ears, shape of ears, location of ears relative to a defined part of the head, characteristics of the jaw, dimensions of the neck, dimensions of the shoulders, dimensions of the upper torso, amount of hair and hairstyle, or any combination thereof.

In Example 14, the subject matter of any one or more of Examples 11-13 optionally include wherein reading the output of the motion assessor includes reading an inertial sensor worn by the user.

In Example 15, the subject matter of any one or more of Examples 11-14 optionally include wherein the HRTF is determined based on a measure of similarity between the at least one physical feature of the user and a corresponding at least one physical feature of a reference individual associated with a predefined HRTF.

In Example 16, the subject matter of any one or more of Examples 11-15 optionally include wherein the HRTF is determined based on an HRTF-generating formula.

In Example 17, the subject matter of any one or more of Examples 11-16 optionally include wherein reading the output of the imaging sensor and producing an indication of at least one physical feature of the user are performed during execution of the VE.

In Example 18, the subject matter of any one or more of Examples 11-17 optionally include maintaining a library of reference individuals having defined physical features associated with corresponding HRTFs.

Example 19 is a system for sound source rendering in a virtual reality (VR) system, the system comprising means for executing the method according to any one of Examples 11-18.

Example 20 is at least one machine-readable medium comprising instructions that, when executed on a system for sound source rendering in a virtual reality (VR) system, cause the system to execute the method according to any one of Examples 11-18.

Example 21 is a at least one machine-readable medium comprising instructions that, when executed on a virtual reality (VR) system, cause the VR system to perform: executing an immersive virtual environment that includes at least one virtual sound source; reading an output of a motion sensor to produce an measurement of a motion of the user; reading an output of an imaging sensor and producing an indication of at least one physical feature of the user relevant to sound perception by the user; determining and applying a head-related transfer function (HRTF) based on the at least one physical feature of the user to effect a source direction of sound from the at least one virtual sound source according to a frame of reference of the user based on the motion of the user; and producing a user-perceptible sound from the virtual sound source based on an output of the sound rendering engine, the sound having directional properties based on the HRTF and source direction.

In Example 22, the subject matter of Example 21 optionally includes wherein the reading the output of the imaging sensor includes reading a 3D model of the at least one physical feature of the user relevant to sound perception.

In Example 23, the subject matter of any one or more of Examples 21-22 optionally include wherein the at least one physical feature of the user relevant to sound perception includes at least one physical feature selected from the group consisting of: head size, head shape, size of ears, shape of ears, location of ears relative to a defined part of the head, characteristics of the jaw, dimensions of the neck, dimensions of the shoulders, dimensions of the upper torso, amount of hair and hairstyle, or any combination thereof.

In Example 24, the subject matter of any one or more of Examples 21-23 optionally include wherein the reading the output of the motion assessor includes reading an inertial sensor worn by the user.

In Example 25, the subject matter of any one or more of Examples 21-24 optionally include wherein the HRTF is determined based on a measure of similarity between the at least one physical feature of the user and a corresponding at least one physical feature of a reference individual associated with a predefined HRTF.

In Example 26, the subject matter of any one or more of Examples 21-25 optionally include wherein the HRTF is determined based on an HRTF-generating formula.

In Example 27, the subject matter of any one or more of Examples 21-26 optionally include wherein the means for reading the output of the imaging sensor and producing an indication of at least one physical feature of the user are performed during execution of the VE.

In Example 28, the subject matter of any one or more of Examples 21-27 optionally include maintaining a library of reference individuals having defined physical features associated with corresponding HRTFs.

Example 29 is a system for sound source rendering in a virtual reality (VR) system, the system comprising: means for executing an immersive virtual environment that includes at least one virtual sound source; means for reading an output of a motion sensor to produce an measurement of a motion of the user; means for reading an output of an imaging sensor and producing an indication of at least one physical feature of the user relevant to sound perception by the user; means for determining and applying a head-related transfer function (HRTF) based on the at least one physical feature of the user to effect a source direction of sound from the at least one virtual sound source according to a frame of reference of the user based on the motion of the user; and means for producing a user-perceptible sound from the virtual sound source based on an output of the sound rendering engine, the sound having directional properties based on the HRTF and source direction.

In Example 30, the subject matter of Example 29 optionally includes wherein the means for reading the output of the imaging sensor includes means for reading a 3D model of the at least one physical feature of the user relevant to sound perception.

In Example 31, the subject matter of any one or more of Examples 29-30 optionally include wherein the at least one physical feature of the user relevant to sound perception includes at least one physical feature selected from the group consisting of: head size, head shape, size of ears, shape of ears, location of ears relative to a defined part of the head, characteristics of the jaw, dimensions of the neck, dimensions of the shoulders, dimensions of the upper torso, amount of hair and hairstyle, or any combination thereof.

In Example 32, the subject matter of any one or more of Examples 29-31 optionally include wherein the means for reading the output of the motion assessor includes reading an inertial sensor worn by the user.

In Example 33, the subject matter of any one or more of Examples 29-32 optionally include wherein the HRTF is determined based on a measure of similarity between the at least one physical feature of the user and a corresponding at least one physical feature of a reference individual associated with a predefined HRTF.

In Example 34, the subject matter of any one or more of Examples 29-33 optionally include wherein the HRTF is determined based on an HRTF-generating formula.

In Example 35, the subject matter of any one or more of Examples 29-34 optionally include wherein the means for reading the output of the imaging sensor and producing an indication of at least one physical feature of the user are performed during execution of the VE.

In Example 36, the subject matter of any one or more of Examples 29-35 optionally include maintaining a library of reference individuals having defined physical features associated with corresponding HRTFs.

The above detailed description includes references to the accompanying drawings, which form a part of the detailed description. The drawings show, by way of illustration, specific embodiments that may be practiced. These embodiments are also referred to herein as “examples.” Such examples may include elements in addition to those shown or described. However, also contemplated are examples that include the elements shown or described. Moreover, also contemplated are examples using any combination or permutation of those elements shown or described (or one or more aspects thereof), either with respect to a particular example (or one or more aspects thereof), or with respect to other examples (or one or more aspects thereof) shown or described herein.

Publications, patents, and patent documents referred to in this document are incorporated by reference herein in their entirety, as though individually incorporated by reference. In the event of inconsistent usages between this document and those documents so incorporated by reference, the usage in the incorporated reference(s) are supplementary to that of this document; for irreconcilable inconsistencies, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In the appended claims, the terms “including” and “in which” are used as the plain-English equivalents of the respective terms “comprising” and “wherein.” Also, in the following claims, the terms “including” and “comprising” are open-ended, that is, a system, device, article, or process that includes elements in addition to those listed after such a term in a claim are still deemed to fall within the scope of that claim. Moreover, in the following claims, the terms “first,” “second,” and “third,” etc. are used merely as labels, and are not intended to suggest a numerical order for their objects.

The above description is intended to be illustrative, and not restrictive. For example, the above-described examples (or one or more aspects thereof) may be used in combination with others. Other embodiments may be used, such as by one of ordinary skill in the art upon reviewing the above description. The Abstract is to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. However, the claims may not set forth every feature disclosed herein as embodiments may feature a subset of said features. Further, embodiments may include fewer features than those disclosed in a particular example Thus, the following claims are hereby incorporated into the Detailed Description, with a claim standing on its own as a separate embodiment. The scope of the embodiments disclosed herein is to be determined with reference to the appended claims, along with the full scope of equivalents to which such claims are entitled.

1. A system for sound source rendering in a virtual reality (VR) system, the system comprising:
a modeling engine to execute an immersive virtual environment (VE) that includes at least one virtual sound source;
a motion assessor to read an output of a motion sensor to produce a measurement of a motion of the user during execution of the VE;
a physical feature assessor to read an output of an imaging sensor and produce an indication of at least one physical feature of the user relevant to sound perception by the user, wherein the physical feature assessor is to read an output of an imaging sensor and produce an indication of at least one physical feature of the user during execution of the VE;
a sound rendering engine to determine and apply a head-related transfer function (HRTF) based on the at least one physical feature of the user, and to effect a source direction of sound from the at least one virtual sound source according to a frame of reference of the user based on the motion of the user during execution of the VE; and
a sound output device to produce a user-perceptible sound from the virtual sound source based on an output of the sound rendering engine during execution of the VE, the sound having directional properties based on the HRTF and source direction.

2. The system of claim 1, further comprising:
a motion sensor to measure motion of a user of the VR system; and
an imaging sensor to measure physical features of the user.

3. The system of claim 1, wherein the output of the imaging sensor includes a 3D model of the at least one physical feature of the user relevant to sound perception.

4. The system of claim 1, wherein the at least one physical feature of the user relevant to sound perception includes at least one physical feature selected from the group consisting of:
head size, head shape, size of ears, shape of ears, location of ears relative to a defined part of the head, characteristics of the jaw, dimensions of the neck, dimensions of the shoulders, dimensions of the upper torso, amount of hair and hairstyle, or any combination thereof.

5. The system of claim 1, wherein the motion assessor is to read an inertial sensor worn by the user.

6. The system of claim 1, further comprising:
a head-mounted display operatively coupled to the sound output device.

7. The system of claim 1, wherein the sound rendering engine to determine the HRTF based on a measure of similarity between the at least one physical feature of the user and a corresponding at least one physical feature of a reference individual associated with a predefined HRTF.

8. The system of claim 1, wherein the sound rendering engine to determine the HRTF based on an HRTF-generating formula.

9. (canceled)

10. The system of claim 1, wherein the sound rendering engine includes a library of reference individuals having defined physical features associated with corresponding HRTFs.

11. At least one non-transitory machine-readable storage medium comprising instructions that, when executed on a virtual reality (VR) system, cause the VR system to:
execute an immersive virtual environment (VE) that includes at least one virtual sound source;
read an output of a motion sensor to produce a measurement of a motion of the user during execution of the VE;
read an output of an imaging sensor and produce an indication of at least one physical feature of the user relevant to sound perception by the user during execution of the VE;
determine and apply a head-related transfer function (HRTF) based on the at least one physical feature of the user to effect a source direction of sound from the at least one virtual sound source according to a frame of reference of the user based on the motion of the user during execution of the VE; and
produce a user-perceptible sound from the virtual sound source based on an output of the sound rendering engine during execution of the VE, the sound having directional properties based on the HRTF and source direction.

12. The at least one machine-readable medium of claim 11, wherein to read the output of the imaging sensor includes reading a 3D model of the at least one physical feature of the user relevant to sound perception.

13. The at least one machine-readable medium of claim 11, wherein the at least one physical feature of the user relevant to sound perception includes at least one physical feature selected from the group consisting of:
head size, head shape, size of ears, shape of ears, location of ears relative to a defined part of the head, characteristics of the jaw, dimensions of the neck, dimensions of the shoulders, dimensions of the upper torso, amount of hair and hairstyle, or any combination thereof.

14. The at least one machine-readable medium of claim 11, wherein to read the output of the motion assessor includes reading an inertial sensor worn by the user.

15. The at least one machine-readable medium of claim 11, wherein the HRTF is determined based on a measure of similarity between the at least one physical feature of the user and a corresponding at least one physical feature of a reference individual associated with a predefined HRTF.

16. The at least one machine-readable medium of claim 11, wherein the HRTF is determined based on an HRTF-generating formula.

17. (canceled)

18. The at least one machine-readable medium of claim 11, wherein the VR system is further to maintain a library of reference individuals having defined physical features associated with corresponding HRTFs.

19. A method for sound source rendering in a virtual reality (VR) system, the method comprising:
executing an immersive virtual environment (VE) that includes at least one virtual sound source;
reading an output of a motion sensor to produce a measurement of a motion of the user during execution of the VE;
reading an output of an imaging sensor and producing an indication of at least one physical feature of the user relevant to sound perception by the user during execution of the VE;
determining and applying a head-related transfer function (HRTF) based on the at least one physical feature of the user to effect a source direction of sound from the at least one virtual sound source according to a frame of reference of the user based on the motion of the user during execution of the VE; and
producing a user-perceptible sound from the virtual sound source based on an output of the sound rendering engine during execution of the VE, the sound having directional properties based on the HRTF and source direction.

20. The method of claim 19, wherein reading the output of the imaging sensor includes reading a m3D model of the at least one physical feature of the user relevant to sound perception.

21. The method of claim 19, wherein the at least one physical feature of the user relevant to sound perception includes at least one physical feature selected from the group consisting of:
head size, head shape, size of ears, shape of ears, location of ears relative to a defined part of the head, characteristics of the jaw, dimensions of the neck, dimensions of the shoulders, dimensions of the upper torso, amount of hair and hairstyle, or any combination thereof.

22. The method of claim 19, wherein reading the output of the motion assessor includes reading an inertial sensor worn by the user.

23. The method of claim 19, wherein the HRTF is determined based on a measure of similarity between the at least one physical feature of the user and a corresponding at least one physical feature of a reference individual associated with a predefined HRTF.

24. The method of claim 19, wherein the HRTF is determined based on an HRTF-generating formula.

25. (canceled)
